(19) United States
(12) Patent Application Publication
(10) Pub. No.: US 2008/0181325 A1
(43) Pub. Date: Jul. 31, 2008

(54) APPARATUS AND METHOD FOR CHANNEL ESTIMATION IN AN ORTHOGONAL FREQUENCY DIVISION MULTIPLEXING SYSTEM

(75) Inventors: Jeong-Soon Park, Seoul (KR); Jong-Han Lim, Seoul (KR); Min-Cheol Park, Suwon-si (KR); Myeong-Ae Kang, Suwon-si (KR); Heon Huh, Seoul (KR); Jae-Yong Lee, Yongin-si (KR); Yoo-Chang Eun, Seoul (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 12/023,215

(22) Filed: Jan. 31, 2008

(30) Foreign Application Priority Data
Jan. 31, 2007 (KR) 10-2007-10270

(51) Int. Cl. H04K 1/10

(52) U.S. Cl. 375/260

(57) ABSTRACT

An apparatus and method for estimating a channel in an Orthogonal Frequency Division Multiplexing (OFDM) system is provided. The apparatus and method includes estimating a channel corresponding to a pilot of a received signal, performing a first estimation on a data channel by performing time-domain linear interpolation on pilots of previous and next symbols of the pilot using the channel estimate, performing Infinite Impulse Response (IIR) filtering on the channel estimate and the data channel estimate of the pilots of the previous and next symbols of the pilot, and performing a second estimation on the data channel by performing frequency-domain linear interpolation on a remaining zone which excludes the pilot and the zone that underwent the first estimation.

### PRIORITY

This application claims the benefit under 35 U.S.C. § 119(a) of a Korean Patent Application filed in the Korean Intellectual Property Office on Jan. 31, 2007 and assigned Serial No. 2007-10270, the entire disclosure of which is hereby incorporated by reference.

### BACKGROUND OF THE INVENTION

1. Field of the Invention

The present invention relates generally to an Orthogonal Frequency Division Multiplexing (OFDM) system. More particularly, the present invention relates to an apparatus and method for channel estimation in an OFDM system.

2. Description of the Related Art

As a result of the development of the communication industry and the increasing demand for packet data services, there is an increasing need for communication systems capable of efficiently providing high-speed packet data services. Since conventional communication networks have been developed with an emphasis on voice services, they have relatively narrow data transmission bandwidths and higher service costs. Accordingly, broadband wireless access schemes are being proposed for solving the foregoing problems. One of the proposed broadband wireless access schemes being researched is the Orthogonal Frequency Division Multiplexing (OFDM) scheme.

The OFDM scheme is a multi-carrier transmission scheme. The OFDM scheme converts a serial input symbol stream into parallel signals and then modulates the parallel signals with multiple orthogonal sub-carriers before transmission. The OFDM scheme is ideally suited to digital transmission technologies requiring high-speed data transmission, such as Broadband Wireless Internet, Digital Multimedia Broadcasting (DMB), Wireless Local Area Network (WLAN), etc.

In the OFDM system, typical methods for estimating a channel over which a radio signal is transmitted can be classified into three methods. The first is a method of performing channel estimation based on a pilot signal. The second is a method of performing channel estimation using the data decoded by a decision directed scheme. The third is a blind detection method of estimating a channel without using known data. Generally, in the wireless communication system supporting coherent demodulation, a transmitter transmits a pilot signal for channel estimation, and a receiver for coherent demodulation performs channel estimation based on the received pilot signal.

The method of performing channel estimation based on a pilot signal can be classified into a linear interpolation method, a Minimum Mean Squared Error (MMSE) method and a Maximum Likelihood (ML) estimation method.

The linear interpolation method is a method of linear-interpolating a channel estimate of the pilot along the time/frequency axes (or domains). The linear interpolation method is based on a Least Squares (LS) method and is relatively easy to implement. Herein, the linear interpolation performed along the time domain is called Time linear Interpolation (TI). The linear interpolation performed along the frequency domain is called Frequency linear Interpolation (FI).

The MMSE method is designed to take into account a time/frequency-domain correlation of a channel and a variance of noise. The MMSE method achieves excellent performance, but is difficult to implement due to its high complexity for channel estimation.

The ML estimation method requires a complex Inverse Fast Fourier Transform/Fast Fourier Transform (IFFT/FFT) computation. Accordingly, the ML estimation method is also difficult to implement in a terminal with limited resources.

A detailed description will now be made of a channel estimation method based on the linear interpolation method.

A mobile terminal performs TI on every OFDM symbol in order to obtain a channel estimate from a pilot sub-carrier. After obtaining a channel estimate at intervals of a preset frequency domain for every OFDM symbol, the mobile terminal obtains channel estimates in the full frequency domain using FI. The mobile terminal estimates a time-domain length of a channel. When the estimated time-domain length of the channel is equal to a time-domain length of a Low-Pass Filter (LPF), the mobile terminal suppresses noises, thereby improving channel estimation performance. The channel estimation method based on the linear interpolation method has robust performance in various channel environments.

Channel estimation control logic has been proposed in Institute of Electrical and Electronics Engineers (IEEE) 802.16e that is designed to consider each permutation zone. The entire disclosure of IEEE 802.16e is hereby incorporated by reference. The channel estimation control logic designed to consider each permutation zone is provided to guarantee that the channel estimation performance is robust against channel variation through linear interpolation of a channel estimate estimated from a pilot.

For a Partial Usage of Sub-Channels (PUSC) zone, the mobile terminal performs FI based on four pilot signals received every symbol cluster. Every symbol cluster has two pilots, and when the mobile terminal obtains an average of the received pilot signals of the previous and next symbols of the symbol being estimated, it can obtain a channel estimate corresponding to the remaining two pilot positions. At the start and end of the zone, the mobile terminal extends or copies the received pilot signals of the next or previous symbol, and in this manner, can obtain a regular channel estimate corresponding to 4 pilot positions per symbol. The channel estimate in a data sub-carrier can be obtained by once again applying the linear interpolation method based on the channel estimate obtained from the pilot signals. The channel estimation method based on the linear interpolation method has an advantage since it can effectively estimate a high-frequency/time selectivity channel.

Since the channel estimate significantly affects performance of the terminal, there is a need for a method of improving the performance without increasing hardware complexity. It is possible to expect performance improvement by finding an average of channel estimates along the time domain, rather than using the linear interpolation method. It is also possible to sufficiently find an average without increasing buffer size, by performing one-pole IIR averaging instead of storing all samples used for finding an average. In addition, because a delay for TI is not needed, various control logics for permutation, specified in IEEE 802.16e, can be simplified.

FIG. 1 illustrates channel estimation performances of conventional linear interpolation and conventional Infinite Impulse Response (IIR) filtering in an Additive White Gaussian Noise (AWGN) environment, respectively.

The channel estimation performance of the linear interpolation is a result obtained by estimating a channel using only TI/FI and LPF. It can be appreciated that as an IIR filter coefficient α approaches 1, its performance becomes similar to that of linear interpolation, and as a decreases, the performance is improved.

FIG. 2 illustrates channel estimation performances of conventional linear interpolation and conventional IIR filtering in a slow fading (e.g., 3 Km/h) channel environment, respectively.

It can be noted that the same performance as that in the AWGN channel is shown and as α decreases, the performance by the IIR filter is improved. As shown in FIGS. 1 and 2, it can be noted that in AWGN and slow fading channels, the performance by IIR filtering is improved. In the slow fading channel, when IIR filtering replaces TI of the linear interpolation method, performance improvement and simplification of the zone control logic are possible by using IIR filtering. However, in a fast fading channel, when IIR filtering replaces TI of the linear interpolation method, the performance degradation is noticeable.

That is, in a channel having a low time-varying characteristic using IIR filtering, i.e., in the slow fading channel, an improvement in performance can be achieved. However, in a fast fading channel, there is a significant degradation in performance. The reason for the degradation in performance is that when the channel is updated only in the pilot positions to apply IIR filtering, it is difficult to obtain stable channel estimation performance of the linear interpolation method.

Therefore, there is a need for a channel estimation apparatus and method in an OFDM system, capable of estimating a channel according to the channel environment by combining the advantage of the linear interpolation method with the advantage of IIR filtering.

### SUMMARY OF THE INVENTION

An aspect of the present invention is to address at least the above-mentioned problems and/or disadvantages and to provide at least the advantages described below. Accordingly, an aspect of the present invention is to provide a channel estimation apparatus and method in an Orthogonal Frequency Division Multiplexing (OFDM) system, capable of selectively using an advantage of Infinite Impulse Response (IIR) filtering, based on a linear interpolation method being robust against channel variation.

Another aspect of the present invention is to provide a channel estimation apparatus and method in an OFDM system, capable of bringing performance improvement by applying the linear interpolation method in the fast fading channel and applying an advantage of IIR filtering in a slow fading channel.

Further another aspect of the present invention is to provide a channel estimation apparatus and method in an OFDM system, capable of using the control logic of the existing linear interpolation method without modification.

Yet another aspect of the present invention is to provide a channel estimation apparatus and method in an OFDM system, capable of improving performance of a terminal by using a scheme that performs channel estimation by combining a linear interpolation scheme with a IIR filtering scheme.

According to one aspect of the present invention, a method for estimating a channel in an Orthogonal Frequency Division Multiplexing (OFDM) system is provided. The method includes estimating a channel corresponding to a pilot of a received signal, performing a first estimation on a data channel by performing time-domain linear interpolation on pilots of previous and next symbols of the pilot using the channel estimate, performing Infinite Impulse Response (IIR) filtering on the channel estimate and the data channel estimate of the pilots of the previous and next symbols of the pilot, and performing a second estimation on the data channel by performing frequency-domain linear interpolation on a remaining zone which excludes the pilot and the zone that underwent the first estimation.

According to another aspect of the present invention, a method for estimating a channel in an Orthogonal Frequency Division Multiplexing (OFDM) system is provided. The method includes estimating a channel corresponding to a pilot of a received signal, performing a first estimation on a data channel by performing linear interpolation in a remaining frequency domain, which excludes the pilot, using the channel estimate, and performing a second estimation on the data channel by performing Infinite Impulse Response (IIR) filtering on all sub-carriers of the channel corresponding to the pilot and the data channel estimated by performing linear interpolation.

According to further another aspect of the present invention, apparatus for estimating a channel in an Orthogonal Frequency Division Multiplexing (OFDM) system is provided. The apparatus includes a channel estimator for estimating a channel corresponding to a pilot of a received signal, and for estimating a data channel by combining linear interpolation with Infinite Impulse Response (IIR) filtering based on the channel estimate estimated from the pilot.

According to yet another aspect of the present invention, a method for estimating a channel in an Orthogonal Frequency Division Multiplexing (OFDM) system is provided. The method includes estimating a channel corresponding to a pilot of a received signal, and estimating a data channel by combining linear interpolation with Infinite Impulse Response (IIR) filtering based on the channel estimate estimated from the pilot.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following detailed description taken in conjunction with the accompanying drawings, in which:

FIG. 1 is a diagram illustrating channel estimation performances of conventional linear interpolation and conventional Infinite Impulse Response (IIR) filtering in an Additive White Gaussian Noise (AWGN) environment, respectively;

FIG. 2 is a diagram illustrating channel estimation performances of conventional linear interpolation and conventional IIR filtering in a slow fading channel environment, respectively;

FIG. 3A is a block diagram illustrating a structure of a receiver for performing channel estimation in an Orthogonal Frequency Division Multiplexing (OFDM) system according to an exemplary embodiment of the present invention;

FIG. 3B is a block diagram illustrating a structure of a channel estimator according to an exemplary embodiment of the present invention;

FIG. 3C is a block diagram illustrating a structure of a channel estimator according to another exemplary embodiment of the present invention;

FIG. 4 is a flowchart illustrating a method for selecting an IIR filter coefficient based on to the channel environment according to an exemplary embodiment of the present invention;

FIG. 5 is a flowchart illustrating a channel estimation method in an OFDM system according to an exemplary embodiment of the present invention;

FIG. 6 is a flowchart illustrating a channel estimation method in an OFDM system according to another exemplary embodiment of the present invention;

FIG. 7 is a diagram illustrating an exemplary method of combining a linear interpolation method with IIR filtering according to an exemplary embodiment of the present invention;

FIG. 8 is a diagram illustrating an exemplary method of combining a linear interpolation method with IIR filtering according to anther exemplary embodiment of the present invention;

FIGS. 9A and 9B are diagrams for a description of a channel estimation operation in preamble, Frame Control Header (FCH), and DL-MAP zones according to an exemplary embodiment of the present invention; and

FIG. 10 is a diagram illustrating a channel estimation result in the fast fading channel according to an exemplary embodiment of the present invention.

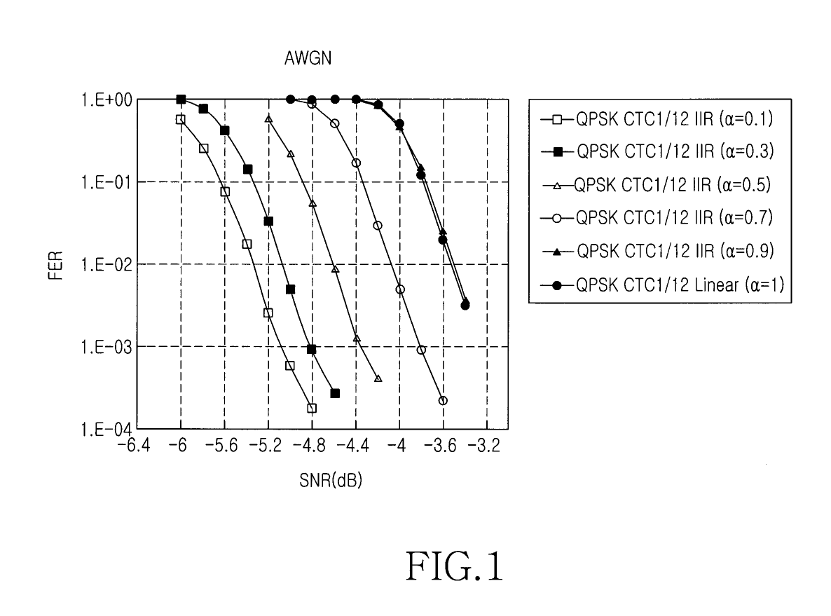

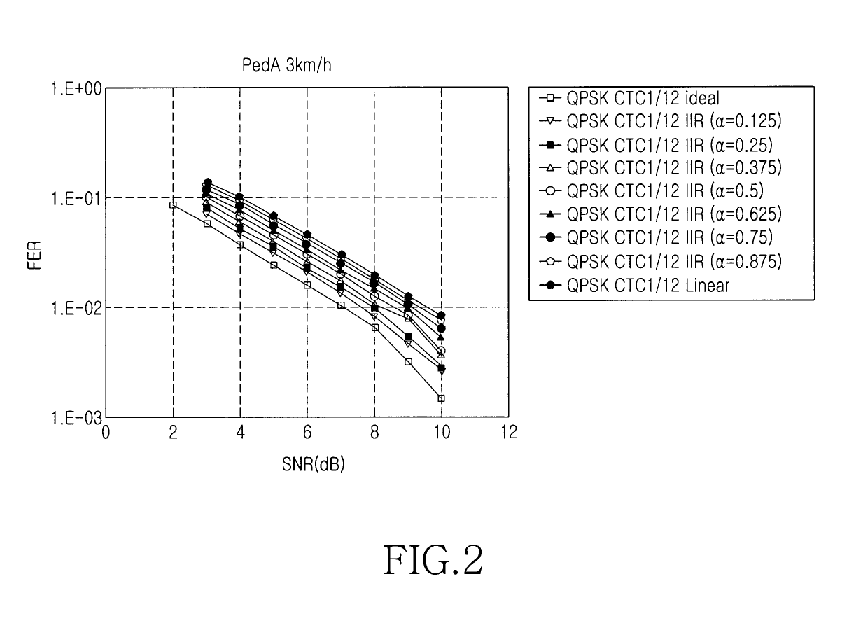

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

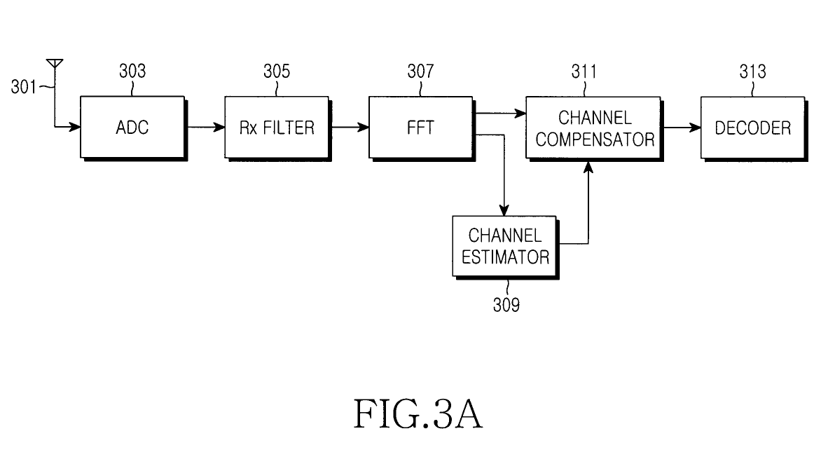

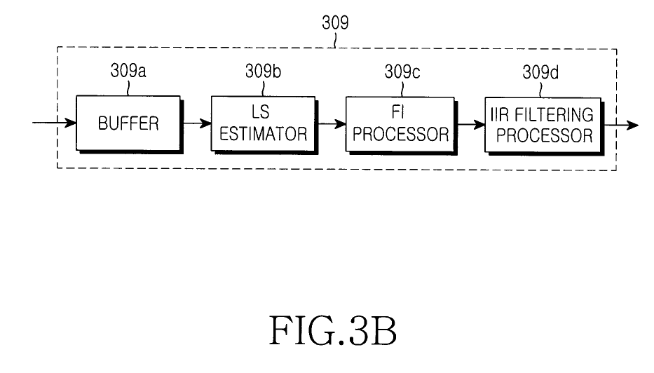

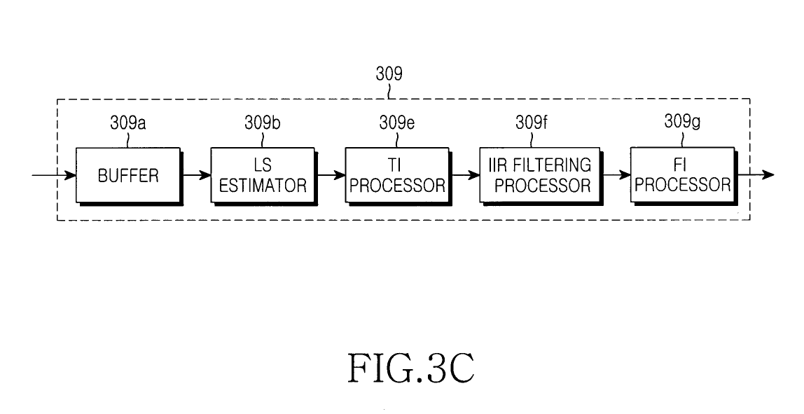

FIG. 3A illustrates a structure of a receiver for performing channel estimation in an Orthogonal Frequency Division Multiplexing (OFDM) system according to an exemplary embodiment of the present invention.

The OFDM receiver of FIG. 3A includes an Analog-to-Digital Converter (ADC) 303 for converting an analog signal received via an antenna 301 into a digital signal, a reception (Rx) filter 305 for extracting and filtering only the service-band signal from the received signal, and a Fast Fourier Transformer (FFT) 307 for converting a time-domain received signal into a frequency-domain signal.

In addition, the receiver of FIG. 3A includes a channel estimator (or pilot channel estimator) 309 for estimating a channel corresponding to a pilot of the converted received signal and estimating a data channel by combining linear interpolation with Infinite Impulse Response (IIR) filtering based on the channel estimate updated from the pilot. The receiver of FIG. 3A further includes a channel compensator 311 for compensating signals of the estimated pilot channel and data channel. Also a decoder 313 is included with the receiver of FIG. 3A for decoding the compensated channel signal into the original signal. The channel estimator 309, as shown in FIG. 3B, includes a buffer 309a, a Least Squares (LS) estimator 309b, a Frequency linear Interpolation (FI) processor 309c, and an IIR filtering processor 309d. An alternative channel estimator 309, as shown in FIG. 3C, includes a buffer 309a, an LS estimator 309b, a TI processor 309e, an IIR filtering processor 309f, and an FI processor 309g.

The buffer 309a stores received data. The LS estimator 309b LS-estimates the data stored in the buffer 309a and matches the level of the signal received in the pilot to the received data. The phrase ‘matches the level of the signal received in the pilot to the received data’ means that because the pilot signal is higher in power than the data, it is matched to the data in strength by appropriate scaling.

The FI processor 309c of FIG. 3B performs linear interpolation processing in the frequency domain. That is, the FI processor 309c estimates a data channel by performing linear interpolation in the remaining frequency domain, which excludes the pilot signal, using the channel estimate.

The IIR filtering processor 309d, after the FI processing in the frequency domain, performs IIR filtering on all sub-carriers of the channel corresponding to the pilot and the data channel estimate by performing linear interpolation, thereby estimating the data channel.

The TI processor 309e of FIG. 3C performs TI processing in the time domain. That is, the TI processor 309e performs time-domain linear interpolation on the pilots of the previous and next symbols of the pilot using the channel estimate, thereby estimating the data channel.

The IIR filtering processor 309f, after the TI processing in the time domain, performs IIR filtering on the channel estimate and the data channel estimate of the pilots of previous and next symbols of the pilot, before performing FI processing. The FI processor 309g, after the IIR filtering is performed, performs frequency-domain linear interpolation on the remaining zone which excludes the pilot and the zone processed in the TI processor 309e, thereby estimating the data channel. Advantageously, this method can reduce complexity while obtaining the same effect of finding an average along the time domain. The control logic for the linear interpolation channel estimation for a change in the various zones defined in Institute of Electrical and Electronics Engineers (IEEE) 802.16e can be used as described therein.

A detailed description will now be made of an operation of the IIR filtering processor 309f added between the TI processor 309e and the FI processor 309g.

The channel estimate of the pilot position estimated in the channel estimator 309 is updated using Equation (1), and the channel estimate in the data sub-carrier, i.e., the output of the IIR filtering processor 309f, can be obtained by applying the linear interpolation method again, based on the updated channel estimate.

Ĥₖ(n)=α\tilde{H}ₖ(n)+(1−α)Ĥₖ(n−1), 0<α≦1 (1)

Herein, \tilde{H}ₖ(n) is an LS and TI channel estimate of a k^{th} sub-carrier of an n^{th} symbol, where k only has an index of a pilot sub-carrier, and indicates a frequency-domain sub-carrier index.

Because Ĥₖ(n), a channel estimate accumulated through IIR computation, uses a first-order IIR filter, it is obtained by accumulating the pilot sub-carrier channel estimate of an n^{th} symbol to the IIR filtering result of an (n−1)^{th} symbol. It can be noted herein that α=1 is coincident with the linear interpolation method.

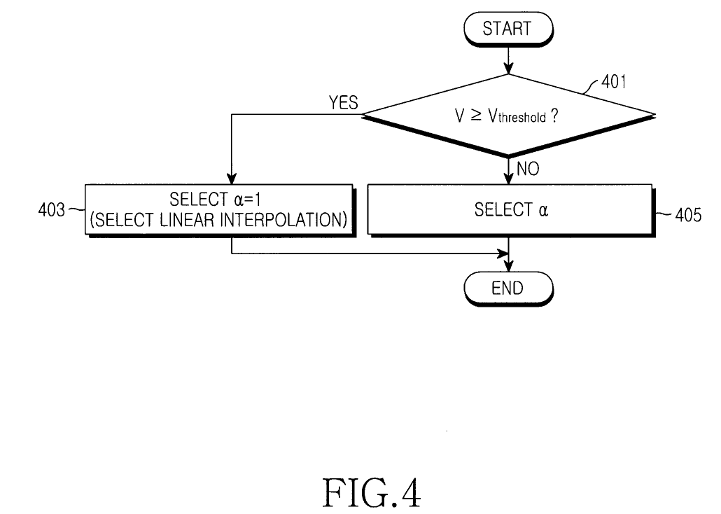

FIG. 4 illustrates an exemplary method for selecting an IIR filter coefficient by a mobile terminal according to the channel environment. The channel environment in FIG. 4 considers only the moving velocity of the mobile terminal.

The mobile terminal determines in step 401 whether a velocity v calculated from a velocity estimate is greater than or equal to a threshold. If the velocity v is greater than or equal to the threshold, the mobile terminal selects α=1 in step 403, thereby selecting the linear interpolation method. However, if the velocity v is less than the threshold, the mobile terminal selects α appropriate for each velocity in step 405, thereby optimizing the performance. Here, the velocity estimate can be measured as a ratio of a long/short-term average of a Carrier-to-Interference and Noise Ratio (CINR) to an average of square errors of the current instantaneous value.

Next, a description will be made of an exemplary method of combining a linear interpolation method with IIR filtering according to an exemplary embodiment of the present invention.

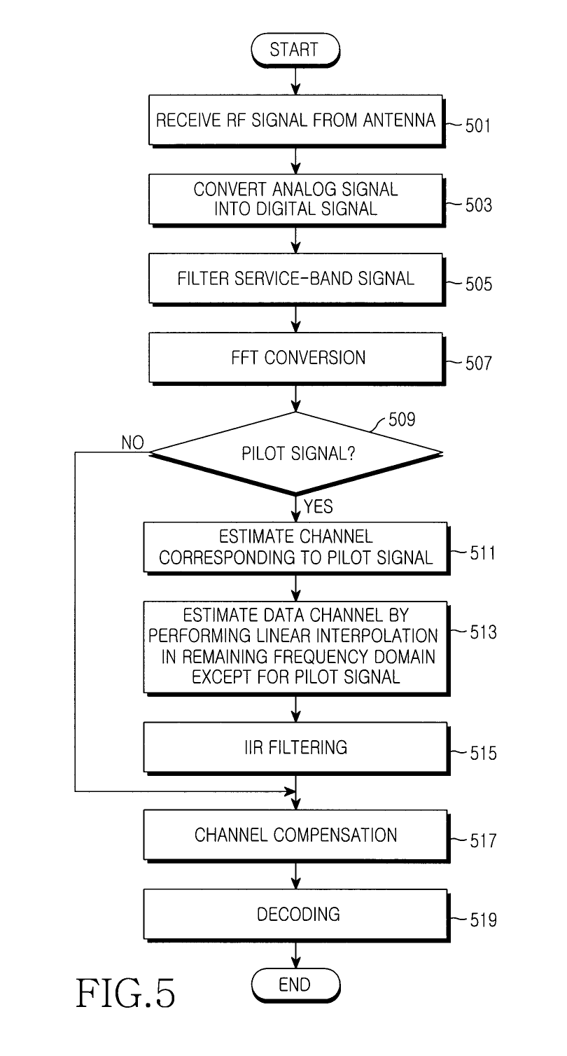

FIG. 5 illustrates a channel estimation method in an OFDM system according to an exemplary embodiment of the present invention.

In step 501, a receiver of FIG. 3A receives a radio signal via an antenna 301 and delivers it to an ADC 303. In step 503, the ADC 303 quantizes the received analog signal into a digital signal, and outputs the digital signal to a reception filter 305. In step 505, the reception filter 305 filters a signal in a preset service band from the received signal. In step 507, an FFT 307 performs a demodulation operation of converting a time-domain signal output from the reception filter 305 into a frequency-domain signal. Upon detecting a pilot signal in the signal output from the FFT 307 in step 509, a channel estimator 309 estimates a channel corresponding to the pilot signal in step 511. Thereafter, in step 513, an FI processor 309c in the channel estimator 309 estimates a channel by performing linear interpolation in the remaining frequency domain, which excludes the pilot signal, using the channel estimate.

Thereafter, in step 515, an IIR filtering processor 309d in the channel estimator 309 performs IIR filtering on all sub-carriers of the channel corresponding to the pilot and the data channel estimated by performing the linear interpolation, thereby estimating the data channel. In step 517, a channel compensator 311 compensates the channel of the received signal using the estimated pilot channel and data channel. In step 519, a decoder 313 decodes the channel-compensated received signal into the original signal.

However, upon failure to detect the pilot signal in the signal output from the FFT 307 in step 509, the channel estimator 309 jumps to step 517 to perform only the channel compensation operation.

Next, a description will be made of an exemplary method of combining a linear interpolation method with IIR filtering according to another exemplary embodiment of the present invention.

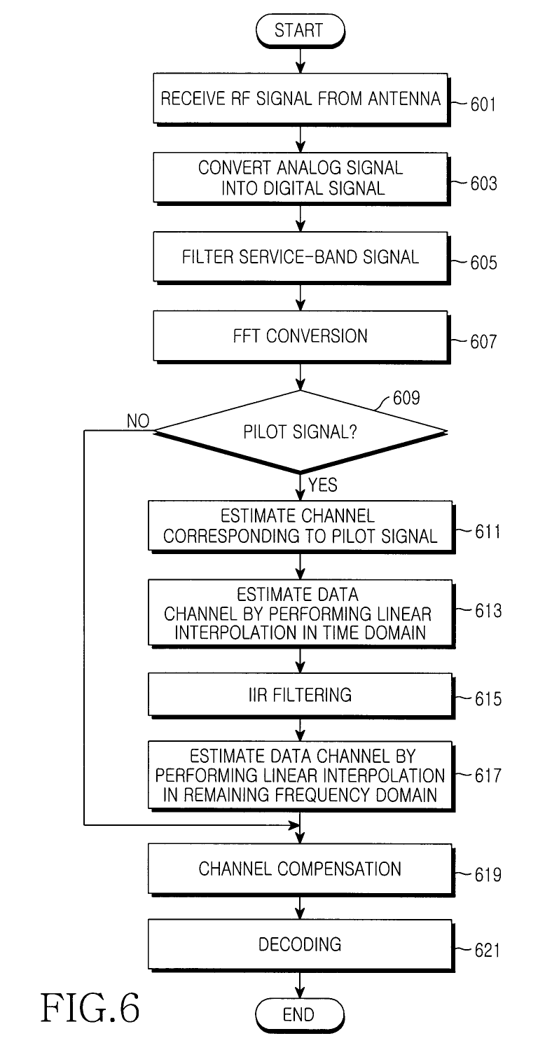

FIG. 6 illustrates a channel estimation method in an OFDM system according to another exemplary embodiment of the present invention.

In step 601, a receiver of FIG. 3A receives a radio signal via an antenna 301 and delivers it to an ADC 303. In step 603, the ADC 303 quantizes the received analog signal into a digital signal, and outputs the digital signal to a reception filter 305. In step 605, the reception filter 305 filters a signal in a predetermined service band from the received signal. In step 607, an FFT 307 performs a demodulation operation of converting a time-domain signal output from the reception filter 305 into a frequency-domain signal. Upon detecting a pilot signal in the signal output from the FFT 307 in step 609, a channel estimator 309 estimates a channel corresponding to the pilot signal in step 611. Thereafter, in step 613, a TI processor 309e in the channel estimator 309 performs time-domain linear interpolation on pilots of the previous and next symbols of the pilot using the channel estimate, thereby estimating the data channel.

Thereafter, in step 615, an IIR filtering processor 309f in the channel estimator 309 performs IIR filtering on the channel estimate and the data channel estimate of the pilots of the previous and next symbols of the pilot, thereby estimating the data channel. In step 617, an FI processor 309g performs frequency-domain linear interpolation on the remaining zone which excludes the pilot signal and the region processed in the TI processor 309e, thereby estimating the data channel. In step 619, a channel compensator 311 compensates the channel of the received signal using the estimated pilot channel and data channel, and in step 621, a decoder 313 decodes the channel-compensated received signal into the original signal.

However, upon failure to detect the pilot signal in the signal output from the FFT 307 in step 609, the channel estimator 309 jumps to step 619 to perform only the channel compensation operation.

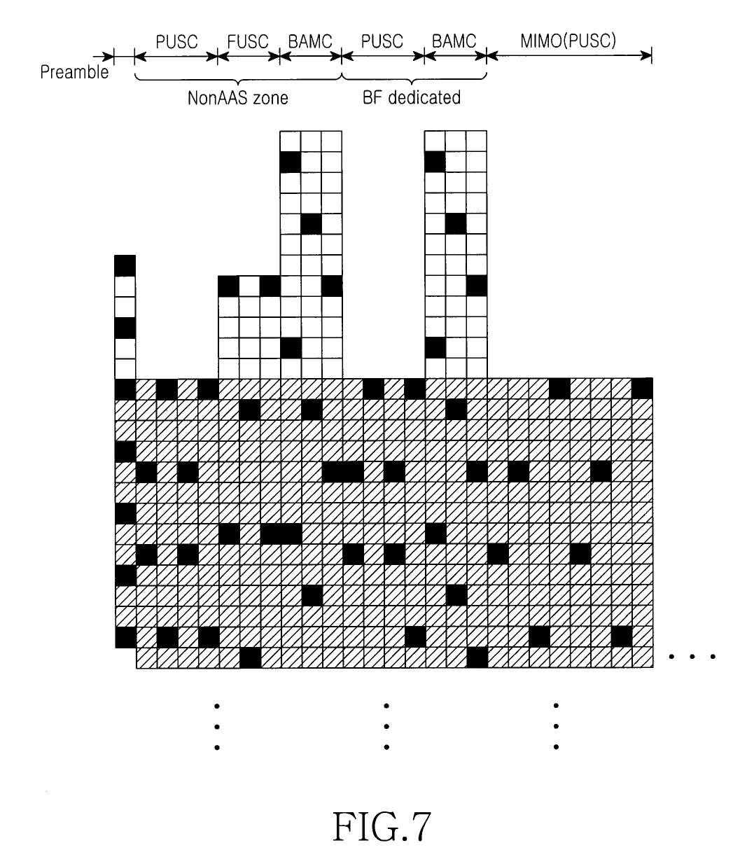

FIG. 7 illustrates an exemplary method of combining a linear interpolation method with IIR filtering according to an exemplary embodiment of the present invention. Shown in FIG. 7 is an exemplary method of combining a linear interpolation method with IIR filtering in the manner described in FIG. 5.

Black squares indicate pilot positions, and parallel-hatched squares indicate a resulting value between pilots, obtained using the linear interpolation method. The IIR filtering is performed in all sub-carriers per symbol.

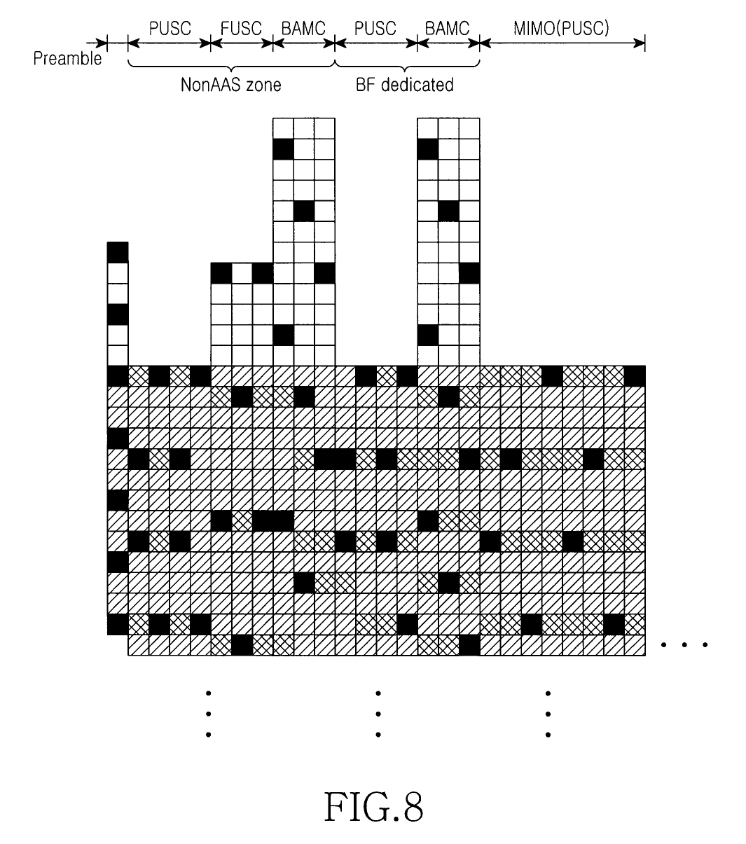

FIG. 8 illustrates an exemplary method of combining a linear interpolation method with IIR filtering according to another exemplary embodiment of the present invention. Shown in FIG. 8 is an exemplary method of combining a linear interpolation method with IIR filtering in the manner described in FIG. 6.

The parallel-hatched squares and pilot positions are made with the linear interpolation method and the extension method (copy method) in a regular pattern per symbol. The IIR filtering is performed in the cross-hatched squares and the black squares of pilot positions, and a value of the parallel-hatched squares is obtained with the linear interpolation method.

Because IIR blocks (cross-hatched squares) affect only the pilot position channel estimate, the control logic of the linear interpolation method can be used without modification. Herein, consideration will be given to the control logic of only the preamble, Frame Control Header (FCH), and DL-MAP zones (or regions).

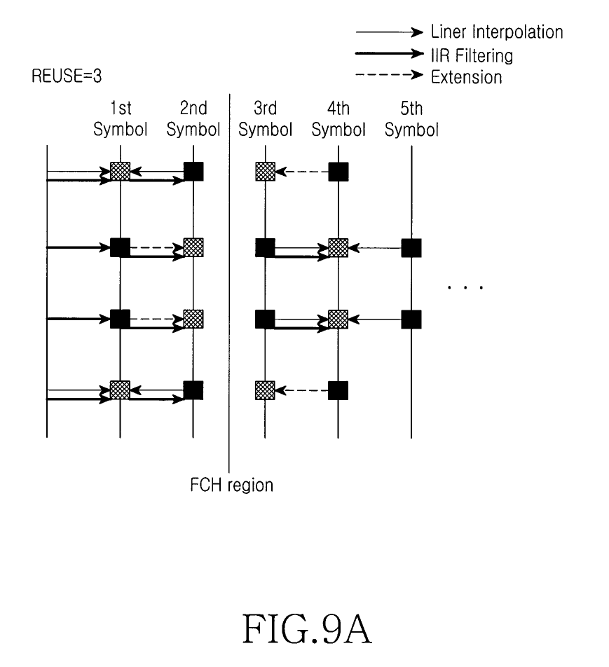

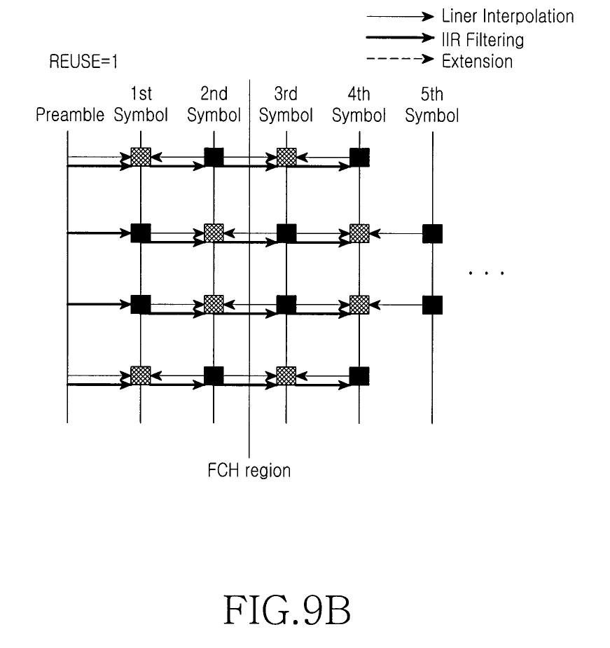

FIGS. 9A and 9B are diagrams for a description of a channel estimation operation in preamble, FCH, and DL-MAP zones.

FIG. 9A is a diagram for a description of a channel estimation operation in the preamble, FCH, and DL-MAP zones for reuse=3, and FIG. 9B is a diagram for a description of a channel estimation operation in the preamble, FCH, and DL-MAP zones for reuse=1. Herein, ‘reuse’ indicates a frequency reuse factor.

In the reuse=3 zone permitted by IEEE 802.16e, because the channel estimate is increased, an average should not be found with the channel estimate in the reuse≠3 zone during TI processing. The channel estimate in the reuse=3 zone undergoes TI only in the corresponding zone, and at the start point of the zone, the extension method in which a channel estimate of the next symbol is extended can be used instead of TI in the sub-carriers other than the pilot sub-carrier.

Before the FCH is decoded, it is difficult to determine whether the first Partial Usage of Sub-Channels (PUSC) zone is a reuse=1 zone or reuse=3 zone. Therefore, it is provided that the channel estimate found in the preamble is used in the first two symbol zones where the FCH exists. Because the preamble undergoes 9 dB boost compared to the traffic, its reliability is higher than that of the channel estimate found by using the pilot (that undergoes 2.5 dB boost). In addition, it is based on the fact that for reuse=3, DL-MAP and UL-MAP can not terminate at the first two symbols. After FCH decoding, for reuse=1, TI and IIR filtering are continuously performed even in the 3rd symbol. However, for reuse=3, even the IIR filtering value that has undergone extension and accumulation instead of TI according to the sub-carrier is unused and reset.

The IIR channel estimate can be expressed as Equation (2).

Ĥₖ(n)=α\tilde{H}ₖ(n)+α(1−α)\tilde{H}ₖ(n−1)+ . . . +α(1−α)ⁱ\tilde{H}ₖ(n−i)+ . . . (2)

Assuming that the received signal has the same average and has undergone i.i.d. (independent and identically distributed), a way of estimating an average by finding a sample mean (or sample average) by measuring N received signals is reduced by 1/N, compared to a way of estimating a variance of the estimate with only one sample. Even the use of IIR filtering can also obtain an effect of finding a sample mean, and it is possible to obtain the effect of covering a window that exponentially decreases, by determining a weight of the previous samples based on which an average is found through the selection of the α value. As α approaches 1, a lower weight is given to the previous samples, so the effect of finding an average for previous samples decreases. However, as α approaches 0, a higher weight is given to the previous samples, so the effect of finding the sample mean may increase.

If the channel does not change with the passage of time, and the average is H̅ₖ, a variance of Ĥₖ(n) can be expressed as Equation (3).

$$\begin{matrix}E [ {\vert {\hat{H}}_{k} ( n ) - {\overline{H}}_{k} \vert}^{2} ] = \frac{{α}^{2}}{1 - {( 1 - α )}^{2}} E [ {\vert {\tilde{H}}_{k} ( n ) - {\overline{H}}_{k} \vert}^{2} ] \\ = \frac{α}{2 - α} E [ {\vert {\tilde{H}}_{k} ( n ) - {\overline{H}}_{k} \vert}^{2} ]\end{matrix} \qquad ( 3 )$$

Therefore, it is possible to make the channel estimate error as small as desired, by decreasing the exponential reduction in the window by which an average is found by selecting a small α value. The variance of Equation (3) is given without considering the point that the variance of the TI output \tilde{H}ₖ(n) is lower than Ĥₖ(n). Therefore, the actual variance is much lower.

This conclusion is based on the assumption that the channel remains unchanged. However, because the channel environment that the terminal experiences varies with the passage of time, the α value should be selected taking into account the moving velocity of the terminal. When the terminal moves at high speed, the α value is increased to exponentially reduce the window, and when the terminal moves at low speed, the α value is decreased to slowly reduce the window.

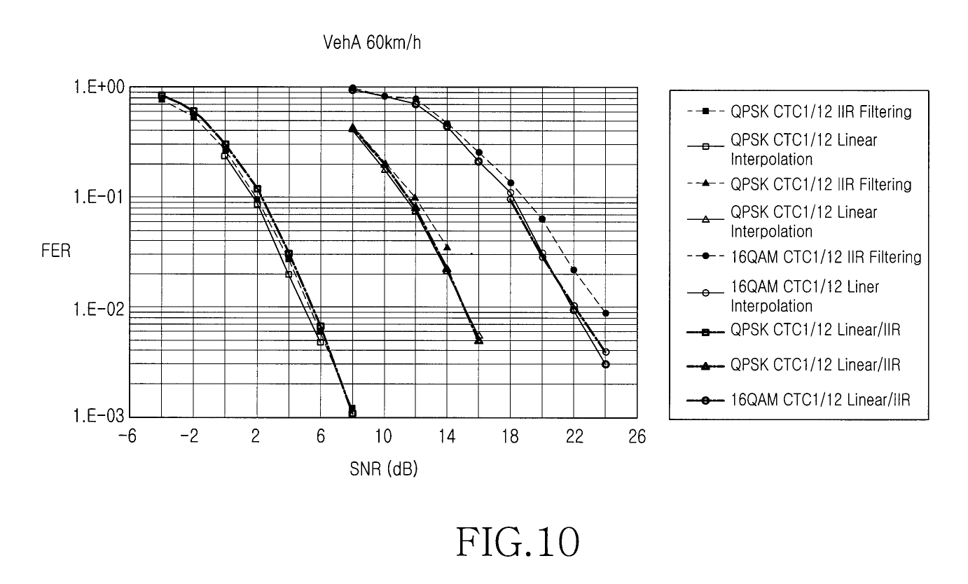

FIG. 10 illustrates a channel estimation result in the fast fading (e.g., 60 km/h) channel.

Shown is the result obtained by sufficiently optimizing a coefficient of the IIR filter according to the moving velocity in a 60 km/h channel environment where the moving velocity of the terminal is relatively high. It can be appreciated from the result that when the linear interpolation method is replaced with IIR filtering, the performance degradation is significant. However, when IIR filtering is applied based on the linear interpolation method, performance improvement can be obtained in a low Modulation and Coding Scheme (MCS) level even in a fast fading channel.

As is apparent from the foregoing description, the exemplary embodiments of the present invention selectively use the merits of IIR filtering based on the linear interpolation method being robust against channel variation, thereby contributing to improved terminal performance.

In addition, the exemplary embodiments of the present invention applies the linear interpolation method in the fast fading channel, and applies the advantage of IIR filtering in the slow fading channel, thereby improving terminal performance.

Further, the exemplary embodiments of the present invention can use the control logic of the existing linear interpolation method without modification.

Moreover, in implementing IIR filtering, exemplary embodiments of the present invention can maintain the merits of the linear interpolation method for fast fading channel.

While the invention has been shown and described with reference to a certain exemplary embodiments thereof, it will be understood by those skilled in the art that various changes in form and details may be made therein without departing from the spirit and scope of the invention as defined by the appended claims and their equivalents.

What is claimed is:

1. A method for estimating a channel in an Orthogonal Frequency Division Multiplexing (OFDM) system, the method comprising:
estimating a channel corresponding to a pilot of a received signal;
performing a first estimation on a data channel by performing time-domain linear interpolation on pilots of previous and next symbols of the pilot using the channel estimate;
performing Infinite Impulse Response (IIR) filtering on the channel estimate and the data channel estimate of the pilots of the previous and next symbols of the pilot; and
performing a second estimation on the data channel by performing frequency-domain linear interpolation on a remaining zone which excludes the pilot and the zone that underwent the first estimation.

2. A method for estimating a channel in an Orthogonal Frequency Division Multiplexing (OFDM) system, the method comprising:
estimating a channel corresponding to a pilot of a received signal;
performing a first estimation on a data channel by performing linear interpolation in a remaining frequency domain, which excludes the pilot, using the channel estimate; and
performing a second estimation on the data channel by performing Infinite Impulse Response (IIR) filtering on all sub-carriers of the channel corresponding to the pilot and the data channel estimated by performing linear interpolation.

3. An apparatus for estimating a channel in an Orthogonal Frequency Division Multiplexing (OFDM) system, the apparatus comprising:
a channel estimator for estimating a channel corresponding to a pilot of a received signal, and for estimating a data channel by combining linear interpolation with Infinite Impulse Response (IIR) filtering based on the channel estimate estimated from the pilot.

4. The apparatus of claim 3, wherein the channel estimator further comprises:
a frequency linear interpolation processor for performing a first estimation on the data channel by performing linear interpolation in a remaining frequency domain, which excludes the pilot, using the channel estimate; and
an IIR filtering processor for performing a second estimation on the data channel by performing IIR filtering on all sub-carriers of the channel corresponding to the pilot and the data channel estimated by performing the linear interpolation.

5. The apparatus of claim 3, wherein the channel estimator further comprises:
a time linear interpolation processor for performing a first estimation on the data channel by performing time-domain linear interpolation on pilots of previous and next symbols of the pilot using the channel estimate;
an IIR filtering processor for performing IIR filtering on the channel estimate and the data channel estimate of the pilots of previous and next symbols of the pilot; and
a frequency linear interpolation processor for performing a second estimation on the data channel by performing frequency-domain linear interpolation on a remaining zone which excludes the pilot and the zone that underwent the first estimation.

6. A method for estimating a channel in an Orthogonal Frequency Division Multiplexing (OFDM) system, the method comprising:
estimating a channel corresponding to a pilot of a received signal; and
estimating a data channel by combining linear interpolation with Infinite Impulse Response (IIR) filtering based on the channel estimate estimated from the pilot.

7. The method of claim 6, further comprising:
performing a first estimation on a data channel by performing linear interpolation in a remaining frequency domain, which excludes the pilot, using the channel estimate; and
performing a second estimation on the data channel by performing IIR filtering on all sub-carrier of the channel corresponding to the pilot and the data channel estimated by performing the linear interpolation.

8. The method of claim 6, further comprising:
performing a first estimation on the data channel by performing time-domain linear interpolation on pilots of previous and next symbols of the pilot using the channel estimate;
performing IIR filtering on the channel estimate and the data channel estimate of the pilots of previous and next symbols of the pilot; and
performing a second estimation on the data channel by performing frequency-domain linear interpolation on a remaining zone which excludes the pilot and the zone that underwent the first estimation.
